(19) United States
(12) Patent Application Publication
(10) Pub. No.: US 2006/0219781 A1
(43) Pub. Date: Oct. 5, 2006

(54) Method of making payment of vehicle charge for transport within a toll zone

(76) Inventor: Mikael Willgert, Spanga (SE)

Correspondence Address: ALFRED J MANGELS, 4729 CORNELL ROAD, CINCINNATI, OH, 452412433, US

(21) Appl. No.: 10/545,823

(22) PCT Filed: Jan. 26, 2004
(86) PCT No.: PCT/SE04/00094

§ 371 Date: Apr. 7, 2006

(30) Foreign Application Priority Data
Feb. 24, 2003 (SE) 0300483-5

(51) Int. Cl. G07B 15/02; G06K 5/00

(52) U.S. Cl. 235/384; 235/382

(57) ABSTRACT

A method for carrying out payment of a vehicle toll for travel within a zone subject to a toll. The vehicle is equipped with a transponder that can be read by a transmitter/receiver unit that transmits a query signal to the transponder. The transponder replies to the query signal and transfers information from a memory in the transponder to the transmitter/receiver unit, which is located at a boundary of the toll zone. The transmitter/receiver unit is connected to a supervisory computer system that debits the owner of the transponder when it is read. When the computer system has received information that a transponder has been read, the computer system sends an SMS message to the mobile telephone of the owner of the transponder, and/or an e-mail message to the mobile telephone of the owner or to a computer that is possessed by the owner.

### BACKGROUND OF THE INVENTION

1. Field of the Invention

The present invention relates to a method for carrying out payment of a vehicle toll for travel within a toll zone.

2. Description of the Related Art

The application of tolls for the right to drive in by car has recently been started in a number of towns.

A system exists in Oslo in which a toll must be paid when the vehicle passes a toll station along the boundary of the city region that is subject to the toll. Payment may be made by subscribers through a transponder in the vehicle, the transponder being read each time the vehicle passes a toll station on its way into the city region.

The system that is now being used in London functions in the manner that any person who wants to drive into the central part of London must pay using a fixed telephone, using SMS from a mobile telephone, using post, or at selected payment locations. Payment may be made before the driver drives into the zone subject to the toll, or after the driver has driven into the zone. Once the driver has driven into the zone, payment may be made at the normal price before 22.00 o'clock.

The system in London functions, in contrast to the system in Oslo, such that a vehicle may pass into and out of the zone that is subject to the toll an unlimited number of times during the period for which the toll has been paid.

A number of video cameras are located within the zone that is subject to the toll in London, and these video cameras photograph the registration plates of the vehicles. The cameras are solely a means for checking. The registration numbers that are obtained from the cameras are compared with the registration numbers for which payment has been made. A fine is levied in the case in which a registration number is identified for which payment has not been made.

Even if in the London system payment can take place by the different methods described above, payment requires a positive action from a driver when he or she drives into the zone or after he or she has driven into the zone. This is in the context time-consuming and can require that the vehicle must be stopped or must return to a payment location in order to carry out the necessary payment.

Due to the different manners in which payment may be made and due to the fact that one may pass into the zone repeatedly following a single payment, it is desirable to be able to use an automatic payment system and to obtain simply a confirmation that payment has been made.

The present invention offers a simple and inexpensive solution to the problem of making a payment.

### SUMMARY OF THE INVENTION

The present invention thus relates to a method for carrying out payment of a vehicle toll for travel within a zone subject to a toll. The vehicle in question is equipped with a transponder that can be read by means of a transmitter/receiver unit arranged to transmit a query signal to the transponder. The transponder is arranged to reply to the query signal and at that time to transfer information from a memory in the transponder to the transmitter/receiver unit. The transmitter/receiver unit is located at the boundaries of the toll zone and is connected to a supervisory computer system that debits the owner of the transponder when it is read. When the computer system has received information that a certain transponder has been read, the computer system sends an SMS message to the mobile telephone of the owner of the transponder, and/or an e-mail message to the mobile telephone of the owner, or to a computer that is possessed by the owner.

### BRIEF DESCRIPTION OF THE DRAWING

The invention will be described in more detail below, partially in association with an embodiment of the invention shown in the attached drawing in which:

FIG. 1 shows schematically a communication link; and

FIG. 2 shows a block diagram of how the invention is used.

### DESCRIPTION OF THE PREFERRED EMBODIMENTS

The present invention concerns a method for carrying out payment of a vehicle toll for travel within a zone subject to a toll. The vehicles in question are equipped with respective transponders 6, 8, 9. Each transponder 6, 8, 9 can be read by means of a transmitter/receiver unit 10, 11, 12 that is arranged to transmit a query signal to the transponder 6, 8, 9 in question. The transponder is arranged to reflect the query signal that is modulated by information contained in a memory in the transponder, and the transmitter/receiver unit is arranged to receive the reflected and modulated query signal.

Different automatic identification systems that use radio frequencies, known as “RFID” (Radio Frequency Identification) systems are available, which systems contain identification tags (ID-tags) and communicators. The applicant supplies such identification systems.

It is appropriate that the ID-tag is applied to the inner surface of the windscreen of the vehicle that is to be identified. The identity can be read by a communicator located at a certain short distance, such as, for example, 5-10 meters. It is also possible, depending on the design, to read and write other information into the ID-tag with the aid of the communicator, in addition to reading and writing an identity.

The relatively short range makes it possible to communicate with the ID-tags within a geographically limited region of communication.

It is preferred that such an RFID-system is used when realizing the present invention.

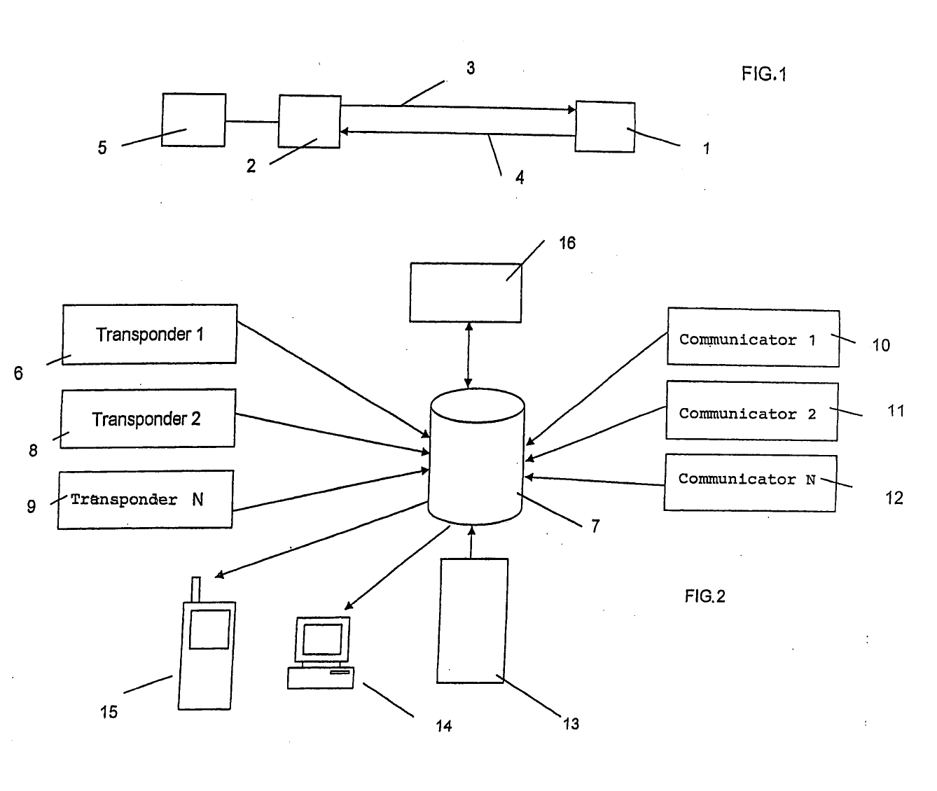

A communication unit for the identification of vehicles is shown in FIG. 1. The communication unit comprises a transponder 1 and a communicator 2 in the form of a receiver/transmitter unit. The communicator 2 is arranged to transmit a query signal 3 to the transponder 1. The transponder is arranged to receive the query signal and thereby reflect and modulate the query signal. The communicator 2 is arranged to receive the reflected signal 4 and to decode its information content.

The information in reflected signal 4 contains at least information about the registration number of the vehicle, or a code that can be associated with the registration number of the vehicle.

The transmitter/receiver units 10, 11, 12 are located at the boundaries of the zone, appropriately in a portal that extends over all lanes of the road. It is appropriate that one transmitter/receiver unit is available for each lane. The transmitter/receiver unit thus reads transponders that pass under the portal.

The transmitter/receiver units 10, 11, 12 are connected to a supervisory computer system including a database 7 and a computer 16. The connection to the supervisory computer system 5, 16 can be made by means of cable, radio, W-Lan, GSM/GPRS/G3, or similar.

The computer system 16 debits the owner of the transponder the toll that has been set when the transponder is read.

The computer system, according to the invention, when it has received information that a certain transponder has been read, transmits an SMS message to the mobile telephone 15 of the owner of the respective transponder 6, 8, 9, and/or an e-mail message to the mobile telephone 15 of the owner, or to a computer 14 that is possessed by the owner.

According to one preferred embodiment, the SMS message or the e-mail message contains information about the time period that is covered by the payment that has been made.

It is further preferred that the computer system 16 debits an account or a credit card that belongs to the owner.

Reference numeral 13 in FIG. 2 denotes the above-mentioned cameras. The registration numbers that have been read by means of the cameras 13 are stored in the database 7, after which the computer 16 compares the registration numbers that have been read with the registration numbers of vehicles for which payments have been made by means of the reading of transponders.

The arrows in FIG. 2 pointing into the database 7 illustrate that the information in the transponders and the information in the communicators is transferred to the database 7.

The present invention can, instead of the design that is shown in FIG. 2, be applied in a separate computer system with a computer and database, which separate computer system is connected to the computer system 16, 7.

It is apparent that the present invention solves the problems that are described above.

A number of embodiments of the present invention have been described above. It is, however, clear that these can be modified.

The present invention is, for this reason, not to be considered as limited to the embodiments described above. The invention can be varied within the scope of the accompanying claims.

What is claimed is:

1. A method for carrying out payment of a vehicle toll for travel within a zone subject to a toll, where the vehicle in question is equipped with a transponder (6, 8, 9) that can be read by means of a transmitter/receiver unit (10, 11, 12) arranged to transmit a query signal to the transponder, where the transponder (6, 8, 9) is arranged to reply to the query signal and at this time to transfer information into a memory in the transponder, and where the transmitter/receiver unit (10, 11, 12) is arranged to receive this information, which transmitter/receiver unit is located at the boundaries of the zone and is connected to a supervisory computer system (16), which computer system is caused to debit the owner of the transponder (6, 8, 9) when it is read, characterised in that, when the computer system (16) has received information that a certain transponder (6, 8, 9) has been read, the computer system (16) is caused to send an SMS message to the mobile telephone (15) of the owner of the transponder and/or an e-mail message to the mobile telephone (15) of the owner or to a computer (14) that is possessed by the said owner.

2. A method according to claim 1, characterised in that the said SMS message or the said e-mail message contains information about the time that is covered by the payment.

3. A method according to claim 1 or 2, characterized in that the computer system (16) is caused to debit an account or a credit card that belongs to the owner.

4. A method according to claim 1, 2 or 3, characterized in that the said transponder (6, 8, 9) is an RFID transponder.
